(19) United States
(12) Patent Application Publication
(10) Pub. No.: US 2010/0119758 A1
(43) Pub. Date: May 13, 2010

(54) PERSONALIZABLE REMOVABLE SELF-ADHESIVE FILM PRODUCTS, AND METHODS OF FABRICATING AND UTILIZING SAME

(76) Inventor: Christopher S. AUTTERSON, Novi, MI (US)

Correspondence Address: WEINER & BURT, P.C., 635 N US-23, POB 186, HARRISVILLE, MI, 48740, US

(21) Appl. No.: 12/582,114

(22) Filed: Oct. 20, 2009

Related U.S. Application Data
(60) Provisional application No. 61/114,062, filed on Nov. 12, 2008.

(51) Int. Cl. B32B 7/12; B32B 27/32

(52) U.S. Cl. 428/41.3; 428/41.8; 428/41.7

(57) ABSTRACT

A personalizable, removable, self-adhesive film product having: a film member provided with a writable/printable surface on a first surface of the film member; a removable pressure-sensitive adhesive layer adjacent a second surface of the film member; the first surface of the film member is opposite the second surface of the film member; and a release liner adjacent the adhesive layer and remote from the film member.

### CROSS-REFERENCE TO RELATED APPLICATIONS

This application claims priority from U.S. Provisional Patent Application 61/114,062 filed Nov. 12, 2008.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to novel and unique personalizable removable self-adhesive film products, and methods of fabricating and utilizing same.

More particularly, the present invention relates to novel and unique personalizable, pressure-sensitive, removable self-adhesive film products which are pre-printed or unprinted, and methods of fabricating and utilizing same.

The prior, but not necessarily relevant, art is exemplified by:

Kulper U.S. Pat. No. 5,843,547;

Schumann United States Patent Application Publication 2006/0257640;

Trigg United States Patent Application Publication 2007/0082162

It is a desideratum of the present invention to avoid the animadversions of conventional and present devices, and at the same time to provide a very convenient and easy to use personalizable, removable, pressure-sensitive film product.

### SUMMARY OF THE INVENTION

The present invention provides a personalizable, removable, self-adhesive film product, comprising: a film member provided with a writable/printable surface on a first surface of said film member; a removable pressure-sensitive adhesive layer provided adjacent a second surface of said film member; said first surface of said film member being opposite said second surface of said film member; and a release liner disposed adjacent said removable pressure-sensitive adhesive layer and remote from said film member.

It is a primary object of the present invention to provide a printed or unprinted self-adhesive film product.

Another object of the present invention to provide a film product as described hereinabove, and which is writable by the user.

A further object of the present invention to provide a film product as described hereinabove, and which is easily removable from any external object.

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is an exploded perspective view of a first embodiment of the present invention.

FIG. 2 illustrates a second embodiment of the present invention.

FIG. 3 illustrates a third embodiment of the present invention.

FIG. 4 illustrates a fourth embodiment of the present invention.

FIG. 5 illustrates a fifth embodiment of the present invention.

FIG. 6 illustrates a sixth embodiment of the present invention.

### DETAILED DESCRIPTION OF THE INVENTION

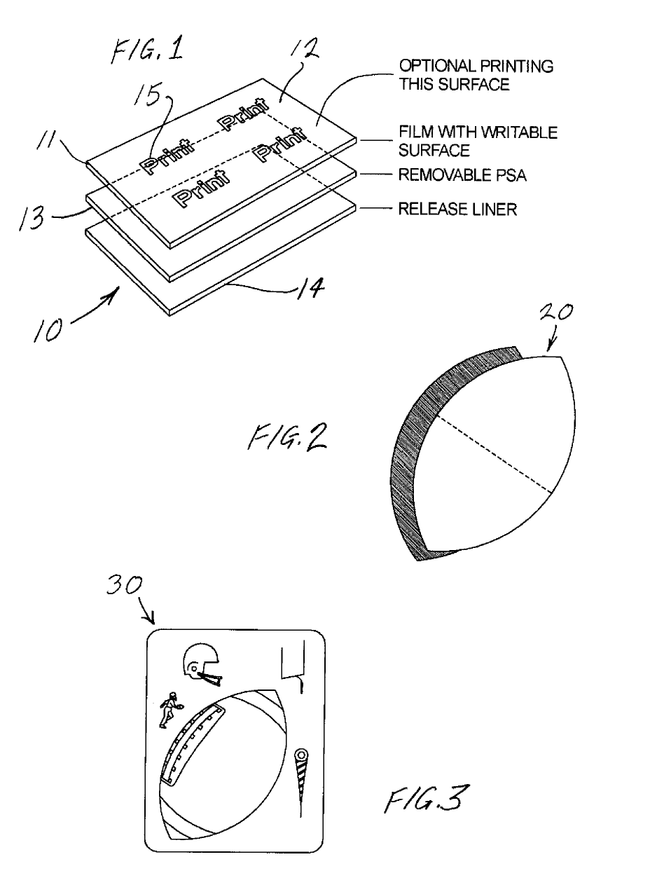

With reference to FIG. 1, there is shown a personalizable film product 10 in accordance with a first embodiment of the invention.

Product 10 includes a film 11 with a writable surface 12, a removable pressure sensitive adhesive (PSA) layer 13, and a release liner 14.

Optionally, the surface 12 may be provided with pre-printing 15 thereon.

Thus, the product 10 can provide printed graphic designs and/or text messages on self-adhesive, removable, protective films.

These printed and die cut films would allow the user to decorate surfaces temporarily, while maintaining the ability to cleanly remove the film when desired.

For example, these printed, removable films could be used to advertise, decorate or communicate hand-written, personal messages on the side of cars and other transportation vehicles, and be removed easily and cleanly when desired.

They may be printed with colorful graphics and die cut to fit the shape and contours of a standard painted metal mailbox in various shapes for temporary decoration applications, such as decoration for holiday greetings or seasonal or sporting event decorations.

The film is can be made out of polypropylene or polyethylene-polypropylene, polyethylene, or vinyl and coated with various weights and tack levels of acrylic- and rubber-based pressure sensitive adhesives.

The end product can be supplied in individual pieces on a release liner, kiss cut on rolls on a release liner (like labels) or perforated on rolls, without a release liner (like paper towels).

FIG. 2 shows a product 20 which may be supplied in individual pieces die cut in accordance with a second embodiment of the present invention.

Product 20 may have a trim-cut perimeter shape, a back-scored release liner to ease installation, and a flood-coat and one-color printed film surface.

FIG. 3 shows a product 30 which may be supplied in sheets with an adhesive matrix.

Product 30 may include pressure sensitive cut perimeter shapes, and an optional four-color printed film surface.

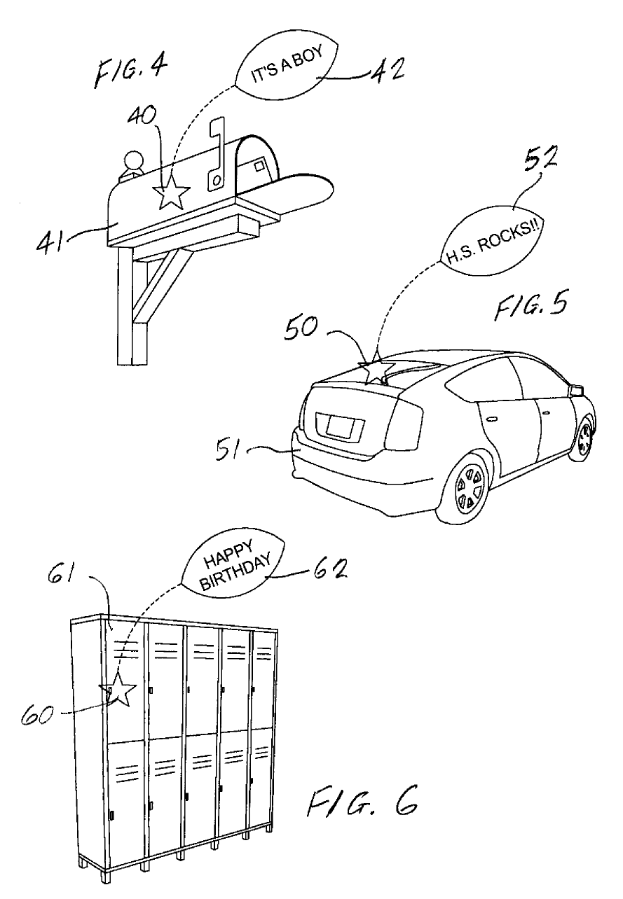

FIG. 4 shows a product 40 which may be die cut to fit the shape and contours of a standard painted metal mailbox 41 for temporary decoration, such as holiday greetings, seasonal decoration, or which is personalizable, for example, with a message which is personalizable, adhered to a common mailbox 41 for temporary decoration, such as for a holiday or with a personal announcement 42.

FIG. 5 shows a product 50 which may be die cut to fit the shape and contours of a vehicle 51 for temporary decoration, such as holiday greetings, seasonal decoration, or which is personalizable, for example, with a message which is personalizable, adhered to a typical automobile 41 for temporary decoration, such as for a sporting event or with a personal announcement 52.

FIG. 6 shows a product 60 which may be die cut to fit the shape and contours of a locker door 61 for temporary decoration, such as holiday greetings, seasonal decoration, or which is personalizable, for example, with a message which is personalizable, adhered to a typical locker door 41 for temporary decoration, such as for a school event or with a personal announcement 62.

The present invention provides personalizable, writable, unprinted or printed, removable, self-adhesive films products.

The inventive film products can be applied to any smooth substrate including cars, trucks, glass or painted metal products, such as mail boxes.

Some of the novel features of the present invention reside in the materials and assemblage of subcomponents thereof.

In accordance with the present invention there is the option with the product to print the film (or leave it unprinted), while allowing the user to put final text or decorative drawings or message on the product.

Examples of this would be die-cutting the shape of a basketball or football and only printing fine background imaging of the seams. This would make the die cut look like a basketball, instead of just a white circle, or football and still allow the user to write all over the surface with the user's own messages.

Any and all such changes, modifications, variations and other uses and applications which do not depart from the spirit and scope of the present invention are therefore covered by and embraced within the claims set forth hereinbelow.

1. A personalizable, removable, self-adhesive film product, comprising;
a film member provided with a writable/printable surface on a first surface of said film member;
a removable pressure-sensitive adhesive layer provided adjacent a second surface of said film member;
said first surface of said film member being opposite said second surface of said film member; and
a release liner disposed adjacent said removable pressure-sensitive adhesive layer and remote from said film member.

2. The personalizable, removable, self-adhesive film product of claim 1, wherein:
said writable/printable surface is provided with pre-printing thereon.

3. The personalizable, removable, self-adhesive film product of claim 1, wherein:
said product is provided with printed graphic designs on a self-adhesive, removable, protective film.

4. The personalizable, removable, self-adhesive film product of claim 2, wherein:
said product is provided with printed graphic designs on a self-adhesive, removable, protective film.

5. The personalizable, removable, self-adhesive film product of claim 1, wherein:
said product is provided with printed text messages on a self-adhesive, removable, protective film.

6. The personalizable, removable, self-adhesive film product of claim 2, wherein:
said product is provided with printed text messages on a self-adhesive, removable, protective film.

7. The personalizable, removable, self-adhesive film product of claim 3, wherein:
said product is provided with printed text messages on said self-adhesive, removable, protective film.

8. The personalizable, removable, self-adhesive film product of claim 4, wherein:
said product is provided with printed text messages on said self-adhesive, removable, protective film.

9. The personalizable, removable, self-adhesive film product of claim 1, wherein:
said film member is made out of polypropylene or polyethylene-polypropylene, polyethylene, or vinyl, and is coated with various weights and tack levels of acrylic- and rubber-based pressure-sensitive adhesives.

10. The personalizable, removable, self-adhesive film product of claim 1, wherein:
said film member is made out of polypropylene or polyethylene-polypropylene, polyethylene, or vinyl, and is coated with various weights and tack levels of acrylic- and rubber-based pressure-sensitive adhesives.

11. The personalizable, removable, self-adhesive film product of claim 2, wherein:
said film member is made out of polypropylene or polyethylene-polypropylene, polyethylene, or vinyl, and is coated with various weights and tack levels of acrylic- and rubber-based pressure-sensitive adhesives.

12. The personalizable, removable, self-adhesive film product of claim 3, wherein:
said film member is made out of polypropylene or polyethylene-polypropylene, polyethylene, or vinyl, and is coated with various weights and tack levels of acrylic- and rubber-based pressure-sensitive adhesives.

13. The personalizable, removable, self-adhesive film product of claim 4, wherein:
said film member is made out of polypropylene or polyethylene-polypropylene, polyethylene, or vinyl, and is coated with various weights and tack levels of acrylic- and rubber-based pressure-sensitive adhesives.

14. The personalizable, removable, self-adhesive film product of claim 5, wherein:
said film member is made out of polypropylene or polyethylene-polypropylene, polyethylene, or vinyl, and is coated with various weights and tack levels of acrylic- and rubber-based pressure-sensitive adhesives.

15. The personalizable, removable, self-adhesive film product of claim 6, wherein:
said film member is made out of polypropylene or polyethylene-polypropylene, polyethylene, or vinyl, and is coated with various weights and tack levels of acrylic- and rubber-based pressure-sensitive adhesives.

16. The personalizable, removable, self-adhesive film product of claim 7, wherein:
said film member is made out of polypropylene or polyethylene-polypropylene, polyethylene, or vinyl, and is coated with various weights and tack levels of acrylic- and rubber-based pressure-sensitive adhesives.

17. The personalizable, removable, self-adhesive film product of claim 8, wherein:
said product is supplied in individual die-cut pieces.

18. The personalizable, removable, self-adhesive film product of claim 1, wherein:
said product is die cut to fit the shape and contours of a mail box, a vehicle or a locker door for temporary decoration, such as holiday greetings, seasonal decoration, or which is personalizable with a message adhered to a locker door for temporary decoration, such as for a school event or with a personal announcement.

19. The personalizable, removable, self-adhesive film product of claim 1, wherein:
said product is supplied in sheets with an adhesive matrix.

20. The personalizable, removable, self-adhesive film product of claim 1, wherein:
said product has a trim-cut perimeter shape, a back-scored release liner to ease installation, and a flood-coat and one-color printed film surface.
